(19) United States
(12) Patent Application Publication
(10) Pub. No.: US 2014/0146794 A1
(43) Pub. Date: May 29, 2014

(54) Modification of Mobility Priority Based on speed of User Equipment and Priority for Cell Operation

(71) Applicant: Lars Dalsgaard, Oulu (FI)

(72) Inventor: Lars Dalsgaard, Oulu (FI)

(73) Assignee: NOKIA CORPORATION, Espoo (FI)

(21) Appl. No.: 14/110,207

(22) PCT Filed: Apr. 8, 2011
(86) PCT No.: PCT/IB2011/051536

§ 371 Date: Dec. 6, 2013

(51) Int. Cl. H04W 36/30; H04W 24/02

(52) U.S. Cl. CPC H04W 36/30; H04W 24/02
USPC 370/332

(57) ABSTRACT

Apparatus, methods, and computer program products implement techniques including accessing mobility priority information of a user equipment and adjusting the mobility priority of the user equipment by applying one or more rules to the mobility priority information based on speed of the user equipment; and performing one or more mobility evaluation procedures based on the adjusted mobility priority. Apparatus, methods, and computer program products implement techniques including accessing priority information corresponding to a plurality of cells in a wireless communications system, and corresponding to a frequency used for communication by the plurality of cells, wherein at least one first cell of the plurality of cells has a range of communication that is at least partially within a range of communication of at least one second cell of the plurality of cells; and performing one or more mobility evaluation procedures based on the accessed priority information.

### TECHNICAL FIELD

This invention relates generally to radio frequency communications and, more specifically, relates to mobility of user equipment in a wireless communications system.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
CSG closed subscriber group
GSM global system for mobile communications
eNB E-UTRAN Node B (evolved Node B)
E-UTRAN evolved UTRAN (LTE)
IE information element
LTE long term evolution of UTRAN (E-UTRAN)
MME mobility management entity
MO management object
NCE network control element
OMA open mobile alliance
PCI physical cell identity
TS technical standard
RAT radio access technology
RRC radio resource control
RLF radio link failure
SIB system information block
SGW serving gateway
UE user equipment, such as a mobile station, mobile node or mobile terminal (user equipment can be singular or plural)
UTRAN universal terrestrial radio access network
WCDMA wideband code division multiple access

Current mobility (e.g., cell change) in a connected mode for a user equipment (such as a cellular phone) is based on a network-controlled handover procedure. See, e.g., 3GPP TS 36.300 V 10.0.0 (2010-06), Chapter 10. Specifically, the network configures the user equipment to perform a given set of measurements by use of, e.g., RRCConnectionReconfiguration and measurement configuration, and to report to the network when a reporting rule is fulfilled (e.g., an evaluation event). Based on the measurements included in the measurement report, the network may act with a handover command (e.g., RRCConnectionReconfiguration including mobility information) when this is needed (as seen from network handover algorithm and e.g. radio conditions point of view). This user equipment-assisted network controlled mobility is based on interactive messaging between the network and the user equipment and relies on the network having detailed knowledge about the overall layout of the network. Such layout includes macro cells and other, smaller cells such as pico cells (a small base station typically serving a small, public area) or femto cells (a small base station typically serving a home or small business). Pico and femto cells can coexist with macro cells. That is, the coverage area of a pico or femto cell may be inside of the coverage area of a macro cell. Including pico and femto cells into a wireless network has certain benefits e.g. adds additional capacity to the network but also has certain problems.

### BRIEF SUMMARY

An exemplary method includes accessing mobility priority information of a user equipment and adjusting the mobility priority of the user equipment by applying one or more rules to the mobility priority information based on speed of the user equipment. The method also includes performing one or more mobility evaluation procedures based on the adjusted mobility priority.

In another exemplary embodiment, a computer program or computer program product includes machine readable instructions which when executed by a user equipment control it to perform the method of the preceding paragraph.

An exemplary apparatus includes means for accessing mobility priority information of a user equipment; means for adjusting the mobility priority of the user equipment by applying one or more rules to the mobility priority information based on speed of the user equipment; and means for performing one or more mobility evaluation procedures based on the adjusted mobility priority.

Another exemplary apparatus includes one or more processors; and one or more memories including computer program code, the one or more memories and the computer program code configured to, with the one or more processors, cause the apparatus to perform at least the following: accessing mobility priority information of a user equipment and adjusting the mobility priority of the user equipment by applying one or more rules to the mobility priority information based on speed of the user equipment; and performing one or more mobility evaluation procedures based on the adjusted mobility priority.

In an additional exemplary embodiment, a method includes determining mobility priority information for user equipment, and selecting one or more rules to be applied to the mobility priority information to effect an adjustment of mobility priority of the user equipment based at least on a speed of the user equipment. The method further includes signaling indications of the determined mobility priority information and the selected one or more rules to the user equipment.

In another exemplary embodiment, a computer program or computer program product includes machine readable instructions which when executed by a base station control it to perform the method of the preceding paragraph.

In a further exemplary embodiment, an apparatus includes means for determining mobility priority information for user equipment, means for selecting one or more rules to be applied to the mobility priority information to effect an adjustment of mobility priority of the user equipment based at least on a speed of the user equipment; and means for signaling indications of the determined mobility priority information and the selected one or more rules to the user equipment.

Another exemplary apparatus includes one or more processors; and one or more memories including computer program code, the one or more memories and the computer program code configured to, with the one or more processors, cause the apparatus to perform at least the following: determining mobility priority information for user equipment, and selecting one or more rules to be applied to the mobility priority information to effect an adjustment of mobility priority of the user equipment based at least on a speed of the user equipment; and signaling indications of the determined mobility priority information and the selected one or more rules to the user equipment.

In yet another exemplary embodiment, a method includes accessing priority information corresponding to a plurality of cells in a wireless communications system, and corresponding to a frequency used for communication by the plurality of cells, wherein at least one first cell of the plurality of cells has a range of communication that is at least partially within a range of communication of at least one second cell of the plurality of cells. The method includes performing one or more mobility evaluation procedures based on the accessed priority information.

In a further exemplary embodiment, a computer program or computer program product includes machine readable instructions which when executed by a user equipment control it to perform the method of the preceding paragraph.

In an additional exemplary embodiment, an apparatus includes means for accessing priority information corresponding to a plurality of cells in a wireless communications system, and corresponding to a frequency used for communication by the plurality of cells, wherein at least one first cell of the plurality of cells has a range of communication that is at least partially within a range of communication of at least one second cell of the plurality of cells; and means for performing one or more mobility evaluation procedures based on the accessed priority information.

Another exemplary apparatus includes one or more processors; and one or more memories including computer program code, the one or more memories and the computer program code configured to, with the one or more processors, cause the apparatus to perform at least the following: accessing priority information corresponding to a plurality of cells in a wireless communications system, and corresponding to a frequency used for communication by the plurality of cells, wherein at least one first cell of the plurality of cells has a range of communication that is at least partially within a range of communication of at least one second cell of the plurality of cells; and performing one or more mobility evaluation procedures based on the accessed priority information.

Another exemplary embodiment is a method that includes determining priority information corresponding to a plurality of cells in a wireless communications system, and corresponding to a frequency used for communication by each of the plurality of cells, wherein at least one first cell of the plurality of cells has a range of communication that is at least partially within a range of communication of at least one second cell of the plurality of cells; and signaling the priority information to user equipment.

In an additional exemplary embodiment, a computer program or computer program product includes machine readable instructions which when executed by a base station control it to perform the method of the preceding paragraph.

Another exemplary embodiment includes an apparatus including means for determining priority information corresponding to a plurality of cells in a wireless communications system, and corresponding to a frequency used for communication by each of the plurality of cells, wherein at least one first cell of the plurality of cells has a range of communication that is at least partially within a range of communication of at least one second cell of the plurality of cells; and means for signaling the priority information to user equipment.

Another exemplary apparatus includes one or more processors; and one or more memories including computer program code, the one or more memories and the computer program code configured to, with the one or more processors, cause the apparatus to perform at least the following: determining priority information corresponding to a plurality of cells in a wireless communications system, and corresponding to a frequency used for communication by each of the plurality of cells, wherein at least one first cell of the plurality of cells has a range of communication that is at least partially within a range of communication of at least one second cell of the plurality of cells; and signaling the priority information to user equipment.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is an illustrative diagram of a user equipment travelling through macro and pico cells.

FIG. 2 is a simplified block diagram of various exemplary apparatus that are suitable for use in practicing the exemplary embodiments of this invention.

FIG. 3 is a logic flow diagram performed by a user equipment for modification of mobility priority based on speed of user equipment that illustrates the operation of a method, and a result of execution of computer program instructions embodied on a computer readable medium, in accordance with the exemplary embodiments of this invention.

FIG. 4 shows examples of mobility priority information.

FIG. 5 shows examples of rules that apply to mobility priority information to adjust mobility priority of a user equipment.

FIG. 6 is a logic flow diagram performed by a base station for modification of mobility priority based on speed of user equipment that illustrates the operation of a method, and a result of execution of computer program instructions embodied on a computer readable medium, in accordance with the exemplary embodiments of this invention.

FIG. 7 is a logic flow diagram performed by a user equipment for implementing priority for intra-frequency cell operation that illustrates the operation of a method, and a result of execution of computer program instructions embodied on a computer readable medium, in accordance with the exemplary embodiments of this invention.

FIG. 8 is a logic flow diagram performed by a base station for implementing priority for intra-frequency cell operation that illustrates the operation of a method, and a result of execution of computer program instructions embodied on a computer readable medium, in accordance with the exemplary embodiments of this invention.

### DETAILED DESCRIPTION OF THE DRAWINGS

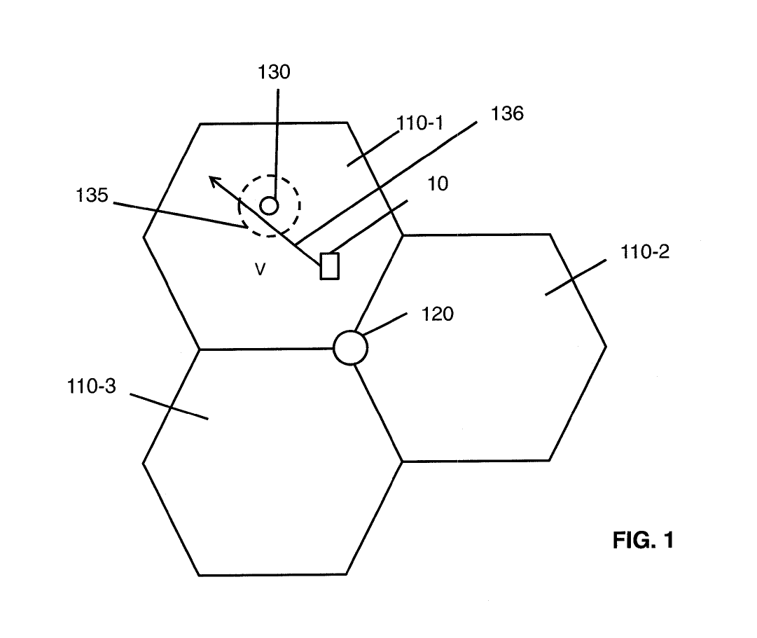

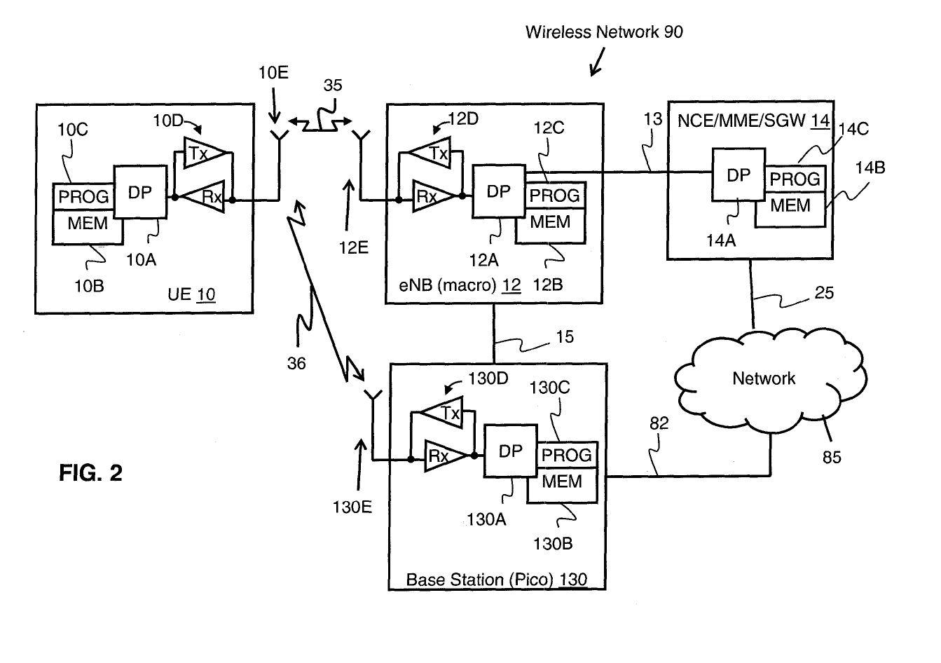

Mobility between macro cells and pico/CSG (closed subscriber group) cells is not always desirable or beneficial from a UE or a network point of view. Consider, for instance, the situation in FIG. 1, in which three macro cells 110-1, 110-2, and 110-3 are shown. The macro cells 110 are created by a cell tower 120 and its associated base stations (not shown in this figure but shown in FIG. 2 as eNB 12). Within macro cell 110-1, there is a pico cell 135 generated by a base station 130. A user equipment 10 is travelling along path 136 at a velocity (also called speed), V.

Assume the user equipment 10 is moving at medium or high speed. In this case, including the pico layer in the mobility (e.g., cell change from user equipment 140 to pico cell 135) could cause a large number of handovers, which is not beneficial from a system level point of view. This is true because the user equipment 10 in FIG. 1 might perform a handover to the pico cell 130 and then, within a short time, a handover back to the macro cell 110-1. In this case, “layer” refers to network layout and deployment. As an example, one can regard frequency as one network layer (e.g., small cells deployed on one carrier while macro cells are deployed on another carrier). As another example one can regard the pico cells as forming the pico cell layer while the macro cells form another layer—all cells deployed on same carrier. It is noted that low, medium, and high speeds are currently defined via technical standards, as described in more detail below. Using above three speed grades (low, medium and high) as example should not be seen as limiting in context of the described idea which can be used also in connection with other speed grades or even speed grades of finer granularity.

A large number of handovers leads to increased signaling both between the user equipment 10 and the network (e.g., increased amounts of measurement reports and handover signaling, new configurations, etc.) as well as in the network internally. Additionally, the increased number of handovers (e.g. as a result of including the pico layer in mobility procedures at high user equipment velocity) might not lead to increased user data throughput but could, on the other hand, lead to reduced user data throughput compared to not performing handover to pico cells. Thus, by not using the pico cell layer in the mobility procedures (in the UE or network) when the UE is travelling at higher speed, this could improve the overall system level performance and mobility as well as improve the mobility robustness in the system. Also for idle mode mobility, it would be desirable to lower the number of cell changes (i.e., mobility) to pico cells when the user equipment is moving at higher speed.

Further, including the pico cells in the mobility procedures when the user equipment is moving at higher speed increases the risk of radio link failure (RLF) in the connected mode, and potential loss of service in the idle mode. This may also call for optimizing the mobility related parameters according to estimated speed (e.g., speed dependent scaling). Speed scaling, as defined currently for idle mode in 3GPP TS 36.304 and for connected mode in 3GPP TS 36.331, works by the network configuring the parameters either by a SIB (system information block), which is broadcast to all UEs and applied to idle mode usage, or in a dedicated manner, such as by measurement configuration for a UE in an RRC connected mode.

Before describing in further detail the exemplary embodiments of this invention, reference is made to FIG. 2 for illustrating a simplified block diagram of various apparatus that are suitable for use in practicing the exemplary embodiments of this invention. In FIG. 2, a wireless network 90 includes an eNB 12, an NCE/MME/SGW 14, and a base station 130 (in this example, generating a pico cell 135). The wireless network 90 is adapted for communication over a wireless link 35 with an apparatus, such as a mobile communication device which may be referred to as a UE 10, via a network access node, such as a Node B (base station), and more specifically an eNB 12. The network 90 may include a network control element (NCE) 14 that may include MME/SGW functionality, and which provides connectivity with a further network, such as a telephone network and/or a data communications network 85 (e.g., the internet) through link 25. The NCE 14 includes a controller, such as at least one computer or a data processor (DP) 14A, and at least one non-transitory computer-readable memory medium embodied as a memory (MEM) 14B that stores a program of computer instructions (PROG) 10C.

The UE 10 includes a controller, such as at least one computer or a data processor (DP) 10A, at least one non-transitory computer-readable memory medium embodied as a memory (MEM) 10B that stores a program of computer instructions (PROG) 10C, and at least one suitable radio frequency (RF) transceiver 10D for bidirectional wireless communications with the eNB 12 via one or more antennas 10E. The eNB 12 also includes a controller, such as at least one computer or a data processor (DP) 12A, at least one computer-readable memory medium embodied as a memory (MEM) 12B that stores a program of computer instructions (PROG) 12C, and at least one suitable RF transceiver 12D for communication with the UE 10 via one or more antennas 12E (typically several when multiple input, multiple output (MIMO) operation is in use). The eNB 12 is coupled via a data and control path 13 to the NCE 14. The path 13 may be implemented as an S1 interface. The eNB 12 may also be coupled to another eNB via data and control path 15, which may be implemented as an X2 interface shown. Typically, the eNB 12 covers a single macro cell 110 via the one or more antennas mounted on the cell tower 120.

In this example, the base station 130 includes a controller, such as at least one computer or a data processor (DP) 130A, at least one computer-readable memory medium embodied as a memory (MEM) 130B that stores a program of computer instructions (PROG) 130C, and at least one suitable RF transceiver 130D for communication with the UE 10 via one or more antennas 130E (as stated above, typically several when multiple input, multiple output (MIMO) operation is in use). The base station 130 communicates with the UE 10 via a link 36. The base station may communicate, depending on implementation, with the eNB 12 using a data and control path 15, or using a link 82 to the network 85 and through the network 85 and the NCE/MME/SGW 14 to the eNB 12. For instance, if the base station 130 is a femto cell, the base station 130 typically connects to an eNB 12 via a link 82.

At least one of the PROGs 10C, 12C, and 130C is assumed to include program instructions that, when executed by the associated DP, enable the corresponding apparatus to operate in accordance with the exemplary embodiments of this invention, as will be discussed below in greater detail. That is, the exemplary embodiments of this invention may be implemented at least in part by computer software executable by the DP 10A of the UE 10 and/or by the DP 12A of the eNB 12, and/or by the DP 130A of the base station 120, or by hardware (e.g., an integrated circuit configured to perform one or more of the operations described herein), or by a combination of software and hardware (and firmware).

In general, the various embodiments of the UE 10 can include, but are not limited to, cellular telephones, tablets having wireless capability, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable memories 10B, 12B, and 130B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The data processors 10A, 12A, and 130A may be of any type suitable to the local technical environment, and may include one or more of general purpose computers, special purpose computers, microprocessors, digital signal processors (DSPs) and processors based on multi-core processor architectures, as non-limiting examples.

As described above, there are certain situations in which a large number of handovers leads to increased signaling both between the user equipment 10 and the network (e.g., increased amounts of measurement reports and handover signaling, new configurations, etc.) as well as in the network internally. The current specifications controlling network and UE behavior include options for use of speed scaling as indicated above. But the current speed scaling does not consider any special techniques when it comes to user equipment speed or network layout (macro, pico cell) in measurement reporting.

For instance, in idle mode, the network configures the UE with measurement instructions using broadcasted information potentially aided with information given in a connection release message (e.g., dedicated priorities). One of the parameters the network can use for controlling UE mobility is priority information. Besides priority information, there is a set of additional parameters included in the broadcast information including, among others, carrier information, offset, speed scaling parameters, and the like.

Details can be found from 3GPP TS 36.304 (concerning idle mode) and 3GPP TS 36.331 (concerning connected mode). Priority information is only used for inter-frequency and inter-RAT mobility. A RAT is, e.g., a unique air/radio interface defined by, for instance, a combination of resources (e.g., carriers having certain frequency ranges), resource spaces (e.g., subcarriers and symbols), and modulations.

Speed scaling of parameters is defined for both idle and connected mode. Currently, speed scaling is applied on given parameters for all cells on a carrier. The following lists the information element from TS 36.331 used for configuring the speed scaling as scaling is performed now (reference is version 8.8.0 of TS 36.331):

1) the SystemInformationBlockType3 information element (page 104);

2) the SpeedStateScaleFactors information element (page 147); and

3) the MeasConfig information element (page 149).

The actual detailed application of the configured parameters is described in TS 36.304 section 5.2.4.3 (idle mode) and TS 36.331 section 5.5.6.2.

Basically, these sections mean that speed scaling is applied for all cells on a given carrier according to signaled parameters, i.e., according to the speed scaling evaluation parameters given in the MobilityStateParameters 1E, the UE determines the current mobility state. Depending on the evaluated speed state, the UE:
1) Scales the timeToTrigger timer in RRC connected mode; or
2) Scales the Qhyst and TreselectionEUTRA in idle mode.
   As mentioned, these parameters are either broadcasted or sent in dedicated signaling and apply for all cells including any macro cells and pico/femto cells.

Note that for idle mode UEs, the network has no visibility to the cell level mobility of the UE and it is therefore not possible for the network to do any detailed UE-specific configuration or changes to configuration. In connected mode, the network may also track the UE mobility (which adds additional network complexity) but reconfiguration of speed scaling parameters on a frequent basis based on estimated UE speed will increase the signaling between UE and network.

Current idle mode specification TS 36.304 also includes support for priority controlled cell reselection. This is described in TS 36.304 section 5.2.4.5. The current approach only allows for carrier level priority handing.

Exemplary embodiments presented here use the UE speed information (e.g., estimation) as input to adjust mobility priority information.

The exemplary embodiments can be readily applied to idle mode mobility for inter-frequency or inter-RAT such that the UE will adjust (e.g., lower/raise) the priority of a given carrier/cell/group of cells priority depending on the UE speed. That is, the priority of the carrier that is mainly used for pico cell deployment or co-channel deployment of macro and pico cells (or the pico cells on that carrier) would be adjusted.

Furthermore, exemplary embodiments can use the potential UE internal speed estimation optimization algorithms or use other aids like GPS (global positioning system) or other positioning approaches, typically without increased signaling.

Also important is the possibility to enable similar functionality for the co-channel deployment scenario. That is, enable priority and priority change for the intra-frequency case—e.g., in case pico cells are deployed on the same carrier as macro cells (called co-channel deployment). In this case, it is proposed in an exemplary embodiment to enable cell level (or cell group) priority for intra-frequency deployment. As mentioned above, the current specification supports priority functionality for idle mode mobility only for inter-frequency or inter-RAT cases.

So the instant exemplary embodiments also include the introduction of priority information (and additionally the newly proposed speed adjustment/scaling of priorities) for connected mode as well as cell level priority handling for idle and connected mode intra-frequency situations.

The exemplary embodiments include at least one or more of the following:
1) Using the UE speed information (e.g., estimation) as input to adjust mobility priority information;
2) Enable cell level (or cell group) priority handling for intra-frequency deployment; and
3) Introduce priority information (and additionally the newly proposed speed adjustment/scaling of priorities) for connected mode.

It should be noted that the issue of estimating UE speed is not considered here. This is outside the scope of the instant invention.

For inter-frequency idle mobility, the existing idle mode priority is readily available for being enhanced with scaling/adjustment according to the current UE speed.

One way this could be realized in a very straightforward approach is to apply already existing speed scaling rules (see TS 36.304) to apply also for changing the priority of certain layers (e.g., carriers) or cells.

This could be realized in detail by the following exemplary techniques:
1) UE will be given measurement information and priorities:
1.1) Carrier 1, priority X and carrier 2, priority Z;
2) Additionally the UE will be given information/rules stating:
2.1) Low speed (e.g., no speed): X=1, Z=2;
2.2) High speed: X=2, Z=1.

For simplicity, this example only considers two speed levels although the current specification has three speed levels: low (no scaling), medium, and high. This basic idea can easily be enhanced to cover additional (e.g., three) speed levels. Also, this example only uses two carriers but it is obviously possible to enhance the basic idea to include more than only two carriers. In general, the idea can be enlarged to cover multiple carrier and/or RATs and multiple carriers on those.

The idle mode UE will, as an example, use the already defined rules (e.g., 3GPP TS 36.304 version 9.4.0, section 5.2.4.3) for estimating its speed. The UE will then use the estimated speed to scale/adjust the broadcasted or otherwise available priority information (as given in the simple inter-frequency example above) according to the following exemplary rules:
1) The UE estimates low speed: use priorities according to Low speed (X=1, Z=2); and
2) The UE estimates high speed: use priorities according to High speed (X=2, Z=1).

This example is based on already agreed-upon idle mode priority functionality concerning inter-frequency priority functionality, but enhanced with speed dependant priority handling by changing the priority according to speed and given rules. In an exemplary embodiment, this is performed internally in UE (e.g., in idle mode) and, e.g., without a need for signaling between UE and network.

The exemplified ways of working with speed-dependent scaling of priority parameters have been described and should not be considered restrictive. Other options for speed scaling of priorities are possible.

In order to enable support for priority information and use this priority information for enhanced co-channel deployment scenarios (mixed macro, pico/femto deployment on the same carrier) it is necessary, in an exemplary embodiment, to introduce cell level or cell group level intra-frequency priority functionality.

Introduction of cell (e.g., or cell group) level intra-frequency priority can be introduced independently from the actual use of priority scaling/adjustment. Priority modification (e.g., scaling or adjustment) can be seen as an additional feature for improving the priority functionality. And the modification (e.g., scaling or adjustment) can be applied on cell, cell group, carrier (e.g., frequency), or RAT level.

One way to introduce cell (e.g., or cell group) level priority, such as for use in an intra-frequency cell group prioritization case, is the following. On a cell level basis, signal (e.g., by broadcast or dedicated signaling) indications of the group, which is split in the form of cell PCIs (physical cell identities), to the user equipment. Additionally, there is a need to signal the group priority and potentially speed dependency (as illustrated in the example above), although group priority for the intra-frequency cell group prioritization case may or may not also involve speed dependency.

It should be noted that ‘intra-frequency’ is seen from a carrier on which UE is camped in connected or idle mode. The same information can be given for inter-frequency carriers.

An example for connected mode under an exemplary embodiment of the instant invention is the following. As described above, priorities are not currently specified for the connected mode. Based on a speed scaling estimation (e.g., as defined already), the UE applies given rules for changing the threshold that indicates when to search for cells on a given layer. This could be performed in multiple ways:
Have a new search threshold in response to a particular speed estimation; such a threshold might indicate not to use a specific carrier/layer (e.g., do not perform cell detection and measurements of the carrier/layer).
Introduce priority in the connected mode and apply the same rule as in idle mode (as described above).
Introduce speed scaling factors (e.g., rules) in measConfig (an information element included into an RRCConnectionReconfiguration message); such rules might state “if high speed, do not use this layer/these cells” (e.g., giving these layer/these cells no priority) or “if high speed, lower the cell detection/measurement priority/frequency of measurement on the layer/carrier” or the opposites (e.g., a high speed UE favors GSM instead of some other RAT).
Perform speed scaling of s-Measure (a threshold when to search for neighbor cells) used in connected mode, potentially with defining a layer specific s-Measure. For s-Measure, see, e.g., 3GPP TS 36.331 V8.8.0 (2009-12), section 6.3.5.

An alternative is to indicate cell size from the network combined with speed preferences. For instance, the network might signal to connected mode UEs indicating PCI of ‘small’ cells. UEs that detect high speed would simply lower the priority of such cells or potentially not trigger events on such cells (if other macro cells are available).

For intra-frequency priority, this idea is more difficult, as UEs (in both idle and connected mode) will identify any intra-frequency cell detectable. This means that cell priority would mean including/excluding cells in mobility procedures based on priority rules. For instance, in idle, the UE would not include a low priority cell in reselection evaluation if a higher priority candidate is available. In connected mode, it could mean excluding/including cells in event evaluation based on the priority of the cell.

Based on the foregoing it should be apparent that the exemplary embodiments of this invention provide a method, apparatus and computer program(s) to provide speed dependent scaling of priority parameters and priority for intra-frequency cell operation.

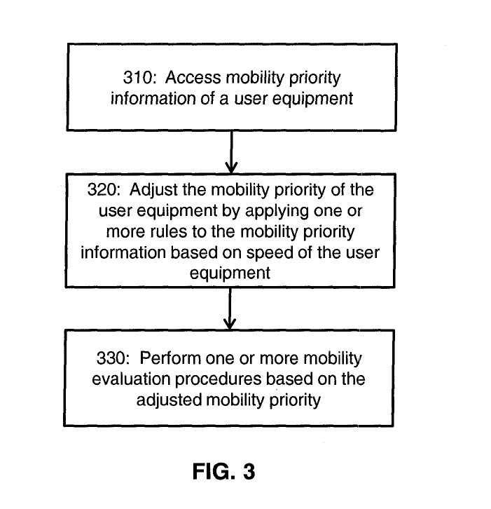

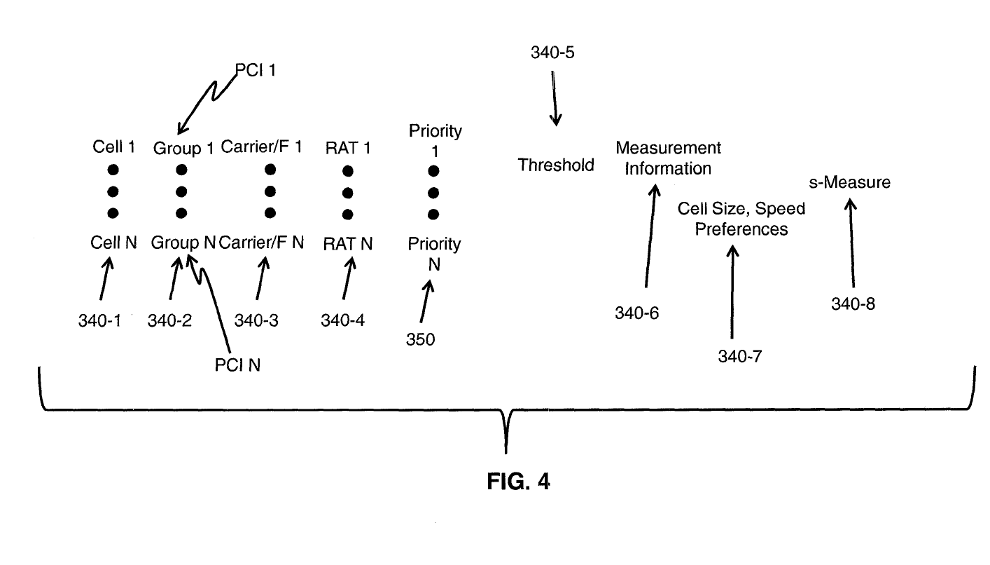

FIG. 3 is a logic flow diagram performed by a user equipment for modification of mobility priority based on speed of user equipment that illustrates the operation of a method, and a result of execution of computer program instructions embodied on a computer readable medium, in accordance with the exemplary embodiments of this invention. In accordance with these exemplary embodiments a user equipment performs, at block 310, an operation of accessing mobility priority information 340. Multiple exemplary mobility priority information 340 are shown in FIG. 3. These include lists of parameters, such as N cells 340-1, groups 340-2 of cells, carriers/frequencies 340-3, and radio access technologies (RAT) 340-4. The groups 340-2 of cells could be defined by PCI, as described above. The radio access technologies could include GSM, WCDMA, LTE, as examples. Shown corresponding to each list 340-1, 340-2, 340-3, and 340-4 of parameters is a priority 350. There are a number of techniques suitable for indicating priority. One is explicit priority values, as shown in FIG. 4. Another is the location within a list of the mobility priority information 340. That is, Cell 1 might have a higher priority than Cell 2, simply because Cell 1 is at the “top” of list and Cell 2 is one location “beneath” Cell 1. As described above, the list 340-1 of parameters may be use to indicate macro cells, pico cells, femto cells or other cells via some type of priority.

Other examples of mobility priority information 340 are (as described above) the threshold 340-5 (e.g., indicating when to search for cells on a given layer), measurement information 340-6 (corresponding to the cell detection/measurement priority/frequency of measurement on the layer/carrier), cell sizes and corresponding speed preferences 340-7, and s-Measure 340-8.

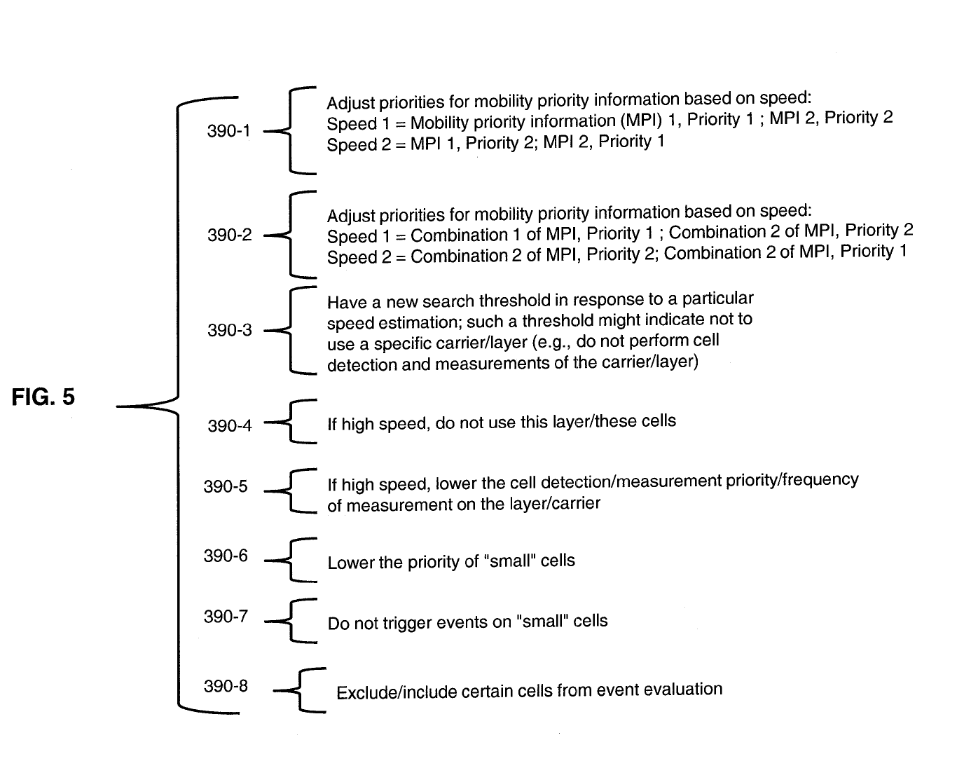

In block 320, the user equipment adjusts the mobility priority of the user equipment by applying one or more rules to the mobility priority information 340 based on speed of the user equipment. Exemplary rules are shown in FIG. 5 and include the following rules:
390-1: Adjust priorities for mobility priority information 340 based on speed (single mobility priority information, MPI); for instance, if speed=Speed 1, carrier 1 (e.g., MPI 1) has priority 1 and carrier 2 (e.g., MPI 2) has priority 2 and if speed=Speed 2, carrier 1 has priority 2 and carrier 2 has priority 1;
390-2: Adjust priorities for mobility priority information 340 based on speed (combination of MPIs); for instance, if speed=Speed 1, cell 1 on carrier 1 (Combination 1 of MPIs) has priority 1 and cell 2 on carrier 1 (Combination 2 of MPIs) has priority 2 and if speed=Speed 2, cell 1 on carrier 1 has priority 2 and cell 2 on carrier 1 has priority 1;
390-3: Have a new search threshold in response to a particular speed estimation; such a threshold might indicate not to use a specific carrier/layer (e.g., do not perform cell detection and measurements of the carrier/layer);
390-4: If high speed, do not use this layer/these cells;
390-5: If high speed, lower the cell detection/measurement priority/frequency of measurement on the layer/carrier;
390-6: Lower the priority of “small” cells;
390-7: Do not trigger events on “small” cells; and
390-8: Exclude/include certain cells from event evaluation.
   These rules 390 have already been described above and are merely exemplary.

It is noted that the mobility priority concerns which of the cells 340-1, groups 340-2 of cells, carriers 340-3, or RATs 340-4 might (or might not) be selected based on a reselection procedure evaluation and priorities associated with the mobility priority information 340. The mobility priority is adjusted via the rules in the manners described above. For instance, if cells are excluded from event evaluation, then the mobility priority is adjusted because certain cells are excluded (e.g., and therefore have “zero” priority; or, put differently, the remaining cells have higher priority relative to the excluded cells). An alternative would be to assign ‘no priority’ to certain group of cells/carriers when priority is adjusted via the manners described above. That is, a user equipment is not required to measure carriers that have not been assigned a priority. Reference 3GPP TS 36.304, section 5.2.4.1, for instance, states the following: ‘The UE shall only perform cell reselection evaluation for E-UTRAN frequencies and inter-RAT frequencies that are given in system information and for which the UE has a priority provided’. This could be performed, e.g., by assigning ‘no priority’ to a parameter that originally had an initial priority. This approach could be enhanced to be used also for intra-frequency cell prioritization. In terms of whether to perform detections/measurements and whether to reduce the frequency of such detections/measurements for certain cells 340-1, groups 340-2 of cells, carriers 340-3, or RATs 340-4, the mobility priority is adjusted because those certain entities now have less priority relative to the entities whose detections/measurements or frequency of the same are not modified.

In block 330, the user equipment performs one or more mobility evaluation procedures based on the adjusted mobility priority. Exemplary mobility evaluation procedures include the following. For idle mode, the user equipment reselection algorithm includes carrier (and RAT) based priority. This means the network (e.g., base station) defines specific priorities for carriers used by the user equipment in the idle mode reselection mobility. This priority information is 1) broadcasted or 2) given in dedicated manner at connection release. As example of functionality (see 3GPP TS 36.304, V9.4.0 (2010-09), sections 5.2.4.1 and 5.2.4.2) the user equipment need not perform measurements on lower priority carriers. And the actual reselection rules in 5.2.4.5 (of TS 36.304) are defined such that if the user equipment is camped on a good enough carrier, the user equipment will not reselect to a carrier of lower priority as long as a good enough cell can be detected on a higher priority layer. This can readily be expanded to cover also cell level priority and any of the other mobility priority information 340. For connected mode, currently, there are no rules in 3GPP TS 36.331 (e.g., V8.8.0 (2009-12)). But examples of mobility evaluation procedures could be that the user equipment would not need to consider lower priority carrier/cells for event evaluation (or reporting) as long as there are other candidates with higher priority available (potentially within some threshold level). This concept may also be extended to any of the other measurement information 340. These exemplifying descriptions are examples of how the invention could be carried out in E-UTRAN.

A mobility evaluation procedure may cause a change between cells 340-1, groups 340-2 of cells, carriers 340-3, or RATs 340-4. Reselections may be based on, e.g., measured RSRP (reference signal received power) from the serving cell and neighboring cells. If the RSRP of a neighboring cell is higher than an RSRP of a serving cell, the UE may perform cell reselection. And this reselection evaluation is performed among the adjusted priority cells.

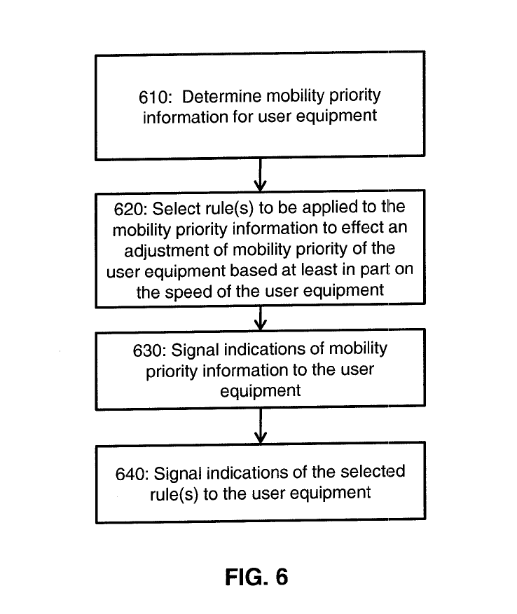

Turning to FIG. 6, a logic flow diagram is shown that is performed by a base station for modification of mobility priority based on speed of user equipment. The flow diagram illustrates the operation of a method, and a result of execution of computer program instructions embodied on a computer readable medium, in accordance with the exemplary embodiments of this invention. In block 610, the base station determines mobility priority information for a user equipment, where the mobility priority information, in an exemplary embodiment, comprises a plurality of parameters and each of the parameters are associated with a corresponding priority. See, e.g., FIG. 4. In block 620, the base station selects one or more rules (e.g., one or more rules 390) to be applied to the mobility priority information to effect an adjustment of mobility priority of the user equipment based at least in part on speed of the user equipment. It should be noted in an exemplary embodiment that the network does not need to determine the speed of the user equipment. In block 630, the base station signals indications of mobility priority information to the user equipment. In block 640, the base station signals indications of selected one or more rules to the user equipment. It is noted, as described above, that in some embodiments, the signaling at least for block 640 may not be performed. If it is the case that block 640 is not performed, then block 620 may or may not be performed. Block 640 and 630 may also be performed with the same signaling.

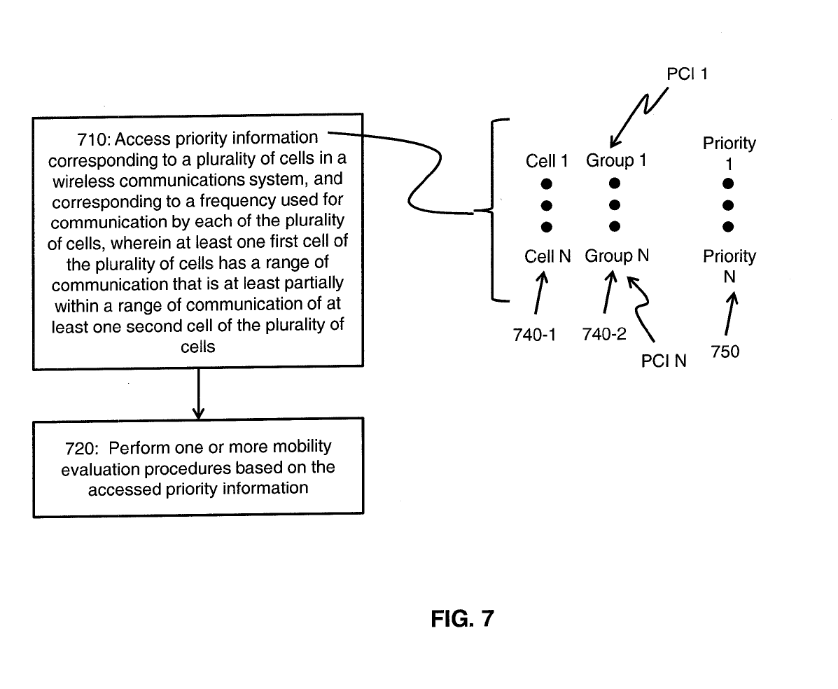

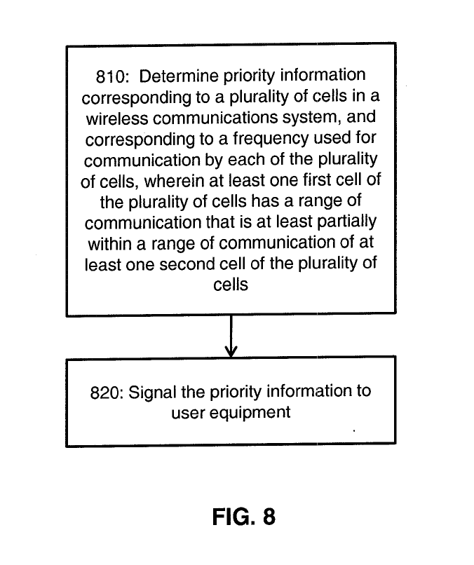

FIG. 7 is a logic flow diagram performed by a user equipment for implementing priority for intra-frequency cell operation that illustrates the operation of a method, and a result of execution of computer program instructions embodied on a computer readable medium, in accordance with the exemplary embodiments of this invention. FIGS. 7 and 8 are related to intra-frequency cell priority handling. In block 710, a user equipment accesses priority information corresponding to a plurality of cells in a wireless communications system. The priority information corresponds to a frequency used for communication by each of the plurality of cells. That is, the N cells 740-1 and group 740-2 of cells (which may be indicated via PCI) all pertain to the same frequency (i.e., carrier) for intra-frequency priority handling. At least one first cell of the plurality of cells has a range of communication that is at least partially within a range of communication of at least one second cell of the plurality of cells. For instance, this is application to the situation shown in FIG. 1, where the range (indicated by reference 135) of the pico cell 135 is within a range (indicated by 110-1) of the macro cell 110-1, if both the cells 130, 110-1 use the same frequency (i.e., carrier).

The cells 740-1 or groups 740-2 of cells are associated with a corresponding priority 750. As described above, there could be an explicit priority 750 or an implicit priority built into the ordering of the cells 740-1 or groups 740-2 of cells.

In block 720, the user equipment performs one or more mobility evaluation procedures based on the accessed priority information. Exemplary mobility evaluation procedures include the following. For idle mode, the user equipment reselection algorithm could include cell and group based priority (as shown in FIG. 7). For connected mode, examples of mobility evaluation procedures could be that the user equipment would not need to consider lower priority cells/groups for event evaluation (or reporting) as long as there are other candidates with higher priority available (potentially within some threshold level). A result of the mobility evaluation procedure may be that the user equipment performs a cell change from one of the plurality of cells to another of the plurality of cells based on the accessed priority information. That is, the same frequency (i.e., carrier) is used on both the initial cell and the new cell after the cell change.

Referring to FIG. 8, a logic flow diagram is shown that is performed by a base station for implementing priority for intra-frequency cell operation. FIG. 8 illustrates the operation of a method, and a result of execution of computer program instructions embodied on a computer readable medium, in accordance with the exemplary embodiments of this invention. In block 810, the base station determines priority information corresponding to a plurality of cells in a wireless communications system, and corresponding to a frequency used for communication by each of the plurality of cells. At least one first cell of the plurality of cells has a range of communication that is at least partially within a range of communication of at least one second cell of the plurality of cells. In block 820, the base station signals the priority information to the user equipment.

It is noted that the techniques shown in FIGS. 7 and 8 may also be combined with any of the techniques described above in reference to FIGS. 3-6.

It should be noted that this approach can also be applied for searching for other access radios than just E-UTRAN. Also, non-3GPP related radio scanning can benefit from a similar approach.

Without in any way limiting the scope, interpretation, or application of the claims appearing below, a technical effect of one or more of the example embodiments disclosed herein is to provide modification of mobility priority based on speed of user equipment. Another technical effect of one or more of the example embodiments disclosed herein is to provide priority for intra-frequency cell operation.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims

1-32. (canceled)

33. A method, comprising:
accessing mobility priority information of a user equipment;
adjusting the mobility priority of the user equipment by applying one or more rules to the mobility priority information based on speed of the user equipment; and
performing one or more mobility evaluation procedures based on the adjusted mobility priority.

34. The method of claim 33, wherein the mobility priority information comprises at least one of:
a plurality of parameters and corresponding initial priority for at least one of the plurality of parameters and wherein adjusting the mobility priority further comprises assigning “no priority” instead of the initial priority for the at least one parameter;
a plurality of parameters and corresponding priority for at least two of the plurality of parameters and wherein adjusting the mobility priority further comprises adjusting the priorities for the at least two parameters; and
at least two combinations of parameters and a corresponding priority for each combination and wherein adjusting the mobility priority further comprises adjusting the priorities associated with the at least two combinations.

35. The method of claim 34, wherein each parameter comprises one of a cell, a group, a carrier, or a radio access technology.

36. The method of claim 33, wherein performing one or more mobility evaluation procedures based on the adjusted mobility priority comprises:
performing a reselection evaluation to determine if, based on the adjusted mobility priority, a reselection from an initial parameter of the mobility priority information to a new parameter of the mobility priority information should be performed; or
performing a reselection to determine if, based on the adjusted mobility priority, a reselection from an initial combination of parameters of the mobility priority information to a new combination of parameters of the mobility priority information should be performed.

37. The method of claim 36, further comprising:
in response to the reselection evaluation determining a reselection from an initial parameter of the mobility priority information to a new parameter of the mobility priority information should be performed, performing a reselection procedure to the new parameter; or
in response to the reselection evaluation determining a reselection from an initial combination of parameters of the mobility priority information to a new combination of parameters of the mobility priority information should be performed, performing a reselection procedure to the new combination of parameters.

38. The method of claim 33, wherein the mobility priority information comprises at least one of:
a list of cells and a corresponding priority for each cell;
a plurality of carriers and a corresponding priority for each carrier; and wherein the method further comprises performing one or more mobility evaluation procedures based on the adjusted mobility priority comprises at least one of:
not considering lower priority cells for one of event evaluation or reporting as long as there is at least one other cell with higher priority available; and
not considering lower priority carriers for one of event evaluation or reporting as long as there is at least one carrier with higher priority available.

39. A computer readable medium comprising machine readable instructions which when executed by a user equipment control it to perform the method of claim 33.

40. An apparatus, comprising:
at least one memory including computer program instructions; and
at least one processor,
wherein the at least one memory and the computer program instructions are configured to, with the at least one processor, cause the apparatus at least to
access mobility priority information of a user equipment,
adjust the mobility priority of the user equipment by applying one or more rules to the mobility priority information based on speed of the user equipment;
and perform one or more mobility evaluation procedures based on the adjusted mobility priority.

41. A method, comprising:
determining mobility priority information for user equipment;
selecting one or more rules to be applied to the mobility priority information to effect an adjustment of mobility priority of the user equipment based at least on a speed of the user equipment; and
signaling indications of the determined mobility priority information and the selected one or more rules to the user equipment.

42. The method of claim 41, wherein the mobility priority information comprises at least one of:
a plurality of parameters and wherein selecting one or more rules further comprises selecting a rule indicating that “no priority” should be assigned to at least one of the plurality of parameters; and
a plurality of parameters and corresponding priority for at least two of the plurality of parameters and wherein selecting one or more rules comprises selecting one or more rules indicating how the priorities for the at least two parameters should be adjusted based on the speed of the user equipment.

43. An apparatus, comprising:
at least one memory including computer program instructions; and
at least one processor,
wherein the at least one memory and the computer program instructions are configured to, with the at least one processor, cause the apparatus at least to
determine mobility priority information for user equipment,
select one or more rules to be applied to the mobility priority information to effect an adjustment of mobility priority of the user equipment based at least on a speed of the user equipment;
and signal indications of the determined mobility priority information and the selected one or more rules to the user equipment.

44. A method, comprising:
accessing priority information corresponding to a plurality of cells in a wireless communications system, and corresponding to a frequency used for communication by the plurality of cells, wherein at least one first cell of the plurality of cells has a range of communication that is at least partially within a range of communication of at least one second cell of the plurality of cells; and
performing one or more mobility evaluation procedures based on the accessed priority information.

45. The method of claim 44, wherein:
the priority information comprises indications of at least first and second cells and a corresponding priority for each of the first and second cells;
performing one or more mobility evaluation procedures based on the accessed priority information further comprises performing a reselection evaluation to determine if reselection should be performed from the first cell at its corresponding priority to the second cell at its corresponding priority; and
wherein the method further comprises:
performing, without changing the frequency, a cell change from the first cell to the second cell in response to the reselection evaluation determining reselection should be performed from the first cell at is corresponding priority to the second cell at its corresponding priority.

46. The method of claim 45, wherein:
the method is performed by a user equipment;
the method further comprises applying one or more rules to the priority information based on speed of the user equipment;
performing one or more mobility evaluation procedures based on the accessed priority information further comprises performing one or more mobility evaluation procedures based on the priority information as modified by the application of the one or more rules to the priority information.

47. An apparatus, comprising:
at least one memory including computer program instructions; and
at least one processor,
wherein the at least one memory and the computer program instructions are configured to, with the at least one processor, cause the apparatus at least to
access priority information corresponding to a plurality of cells in a wireless communications system, and corresponding to a frequency used for communication by the plurality of cells, wherein at least one first cell of the plurality of cells has a range of communication that is at least partially within a range of communication of at least one second cell of the plurality of cells; and
perform one or more mobility evaluation procedures based on the accessed priority information.

48. A method, comprising:
determining priority information corresponding to a plurality of cells in a wireless communications system, and corresponding to a frequency used for communication by each of the plurality of cells, wherein at least one first cell of the plurality of cells has a range of communication that is at least partially within a range of communication of at least one second cell of the plurality of cells; and signaling the priority information to user equipment.

49. An apparatus, comprising:
at least one memory including computer program instructions; and
at least one processor,
wherein the at least one memory and the computer program instructions are configured to, with the at least one processor, cause the apparatus at least to
determine priority information corresponding to a plurality of cells in a wireless communications system, and corresponding to a frequency used for communication by each of the plurality of cells, wherein at least one first cell of the plurality of cells has a range of communication that is at least partially within a range of communication of at least one second cell of the plurality of cells;
and signal the priority information to user equipment.
